(19) United States
(12) Patent Application Publication
(10) Pub. No.: US 2008/0287281 A1
(43) Pub. Date: Nov. 20, 2008

(54) Method For Producing a Wear-Resistant Reaction-Bounded Ceramic Filtering Membrane

(75) Inventors: Peter Bolduan, Ladbergen (DE); Giovanni Catania, Gelsenkirchen (DE); Peter Mund, Munster (DE)

Correspondence Address: Jason H. Vick;Sheridan Ross, PC, Suite # 1200, 1560 Broadway, Denver, CO, 80202, US

(73) Assignee: ATECH INNOVATIONS GMBH, Gladbeck (DE)

(21) Appl. No.: 11/914,309

(22) PCT Filed: May 13, 2006
(86) PCT No.: PCT/EP06/04514

§ 371 Date: Nov. 13, 2007

(30) Foreign Application Priority Data
May 13, 2005 (DE) 10 2005 023 053.9
Jun. 17, 2005 (DE) 10 2005 028 452.3
Jul. 6, 2005 (DE) 10 2005 031 856.8

(51) Int. Cl. C04B 38/02

(52) U.S. Cl. 501/84

(57) ABSTRACT

The invention relates to a method for producing a wear-resistant reaction-bounded ceramic filtering membrane, during which a porous metallic or non-metallic support for producing a green body is provided with a suspension. This suspension is obtained from a dispersant and from a dispersed phase, and this dispersed phase can be obtained from at least one ceramic raw material from the group of metal nitrides and, optionally, from at least one other ceramic raw material. The invention provides that the green body produced in this manner is fired at a temperature ranging from 700° C. to 1250° C. under atmospheric pressure in a oxidizing atmosphere in order to obtain a phase change of at least the ceramic raw material.

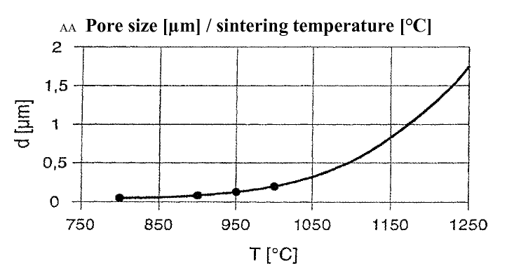

The invention relates to a method as set forth in the preamble of claim 1.

Ceramic filtering membranes, which are also referred to as membrane filters, have a wide variety of uses, for example in the cleaning of exhaust air, in gas purification processes or in purification processes in the foodstuffs industry, the beverage industry, the pharmaceutical industry, the chemical industry, semiconductor production, biotechnology, etc., as well as in the recovery of valuable substances from waste, etc.

Various methods for producing coatings for supports, particularly for producing porous filtration membranes, are known from the prior art. For instance, DE 43 28 295 A1 discloses a method for producing a ceramic sieve filter, with a porous inorganic metallic or non-metallic support being provided with a suspension which has at least one coating agent with at least one ceramic raw material. In the aforementioned method, ceramic raw materials such as oxides, carbides and nitrides of Si, Al, Ti and Zr can be used as coating agents. The thus-obtained green body is subjected to high-pressure and high-temperature treatment in order to achieve a phase change of at least the coating agent. With the previously known method, sieve or membrane filters can be produced with a clearly pre-definable pore size in the macro to nano range. Here, epitaxial growth occurs between the membrane material and the support material, thus resulting in a stress-free microstructural bond which, besides producing high thermal stability, also leads to a high resistance to temperature change.

In DE 43 28 295 A1, a hydrothermal method is described which comprises a high-pressure and high-temperature treatment in an autoclave in which pressures of between 10 bars to 200 bars and temperatures of between 200° C. to 700° C. are present. The pressure in the autoclave is produced by water vapor. It is in the water vapor atmosphere that the bonding of the membrane particles to each other takes place via solution and recrystallization processes. However, the previously known method requires a high level of process intricacy and can [only] be carried out at high cost.

The object of the present invention is to make available a method for producing a wear-resistant reaction-bound ceramic filtering membrane which can be carried out in a simple and cost-effective manner and which, in particular, leads to ceramic filtering membranes which have a clearly definable, uniform pore space distribution, with very good adhesion at the same time between the ceramic raw material and the support.

In order to achieve the aforementioned object, a provision is made in a method with the features of the preamble of claim 1 that the green body is baked at a temperature of 700° C. to 1250° C. under atmospheric pressure in oxidizing atmosphere in order to achieve a phase change of at least the ceramic raw material.

Through the invention, it is possible to produce reaction-bound ceramics using nitrides as a reactive component with low process intricacy and high mechanical stability of the thus-obtainable filtering membrane. The ceramic filter produced according to the inventive method has a high level of strength with a clearly pre-definable pore size in the macro to nano range. An expensive hydrothermal treatment, such as is provided in the prior art in order to obtain filter membranes with comparable characteristics, is not necessary according to the invention. The method according to the invention ensures the coalescence of the membrane particles both among themselves as well as with the support material. This results in a stress-free microstructural bond which leads to a high level of bond strength and a high level of resistance of the filtering membrane.

As a ceramic raw material from the group of the metal nitrides, at least one nitride from the metals titans and/or zirconium can be used. In principle, it is also possible that an aluminum nitride be used. Metal nitrides of a type of metal in pure form or metal nitrides of various metals in mixture can be used. Furthermore, the disperse phase can contain at least one other ceramic raw material from the group of the pure metals, particularly titanium and/or zirconium and/or aluminum. The other ceramic raw material can be selected from the group of the metal oxides, particularly a titanium and/or zirconium and/or aluminum oxide. During baking of the green body, at temperatures of between 700° C. and 1250° C., a reaction between metal nitrides and the other ceramic raw material occurs, hence forming metal oxides. The phase change can preferably be carried out at a temperature of 800° C. to 1000° C., which contributes to particularly good mechanical characteristics of the ceramic filtering membrane according to the invention.

Nitrides are also available as non-explosive nanopowders, making it possible according to the invention to use metal nitrides with a particle size of 0.005 μm to <0.1 μm as the disperse phase for the production of ultrafiltration membranes. In principle, it is of course also possible to use particles with a particle size of >0.1 μm to produce microfiltration membranes. The ultrafiltration membranes produced using the method according to the invention have a high level of resistance to mechanical surface wear (abrasion). As a result of the high strength and wear-resistance, ceramic filters or membranes can be used in applications in which membranes obtained according to the prior art would be abrasively damaged or destroyed. Moreover, filters with small membrane layer thicknesses can be produced, making it possible to reduce the transmembranous pressure during filter operation. It goes without saying that larger particles can also be used to produce a filtering membrane according to the invention, so that the particle size of the solids obtained in the disperse phase can be 0.005 μm to 5 μm.

The proportion of the disperse phase or the solid phase with respect to the mass of the dispersing agent should preferably be approx. 0.1 wt. % to 20 wt. %. This contributes to especially preferred mechanical characteristics of the filtering membrane according to the invention. The dispersing agent can be water and/or at least one alcohol and/or at least one organic gel-forming agent. Moreover, at least one organic dispersing agent can optionally be used. The proportion of the organic gel-forming agent with respect to the mass of the dispersing agent should preferably be approx. 0.1 wt. % to 5 wt. %. The proportion of the dispersing agent with respect to the mass of the disperse phase should preferably be set to approx. 0.1 wt. % to 100 wt. %. It goes without saying that the aforementioned are only preferred values, so greater or lesser proportions are also possible in principle.

The suspension can be applied onto the support through dipping, spraying, brushing, slinging or pumping through a preferably tubular support. If the suspension is applied onto the support through dipping or pumping, then the contact time between the support and the suspension is preferably approx. 1 sec. to 60 sec. In this way, a sufficient coating of the support and the sufficient penetration of the suspension into the support material can be ensured.

In an especially preferred embodiment of the invention, a provision is made that the green body or the green membrane is dried before baking under atmospheric pressure and at a temperature of approx. 20° C. to 250° C. This leads to a pre-solidification between the ceramic particles and the support material.

In order to produce a multilayer filtering membrane, a provision can be made according to the invention that the suspension is applied multiple times, preferably two to five times, particularly three times, to the support. Also preferably, a provision is made that the green body is dried and/or baked again after the application of the suspension. The process of application, drying and baking can hence occur one to five times, with the baking temperature preferably decreasing incrementally during each successive baking process, so that a defined pore structure with decreasing pore size is produced in this manner. For example, the initially formed green body can be baked at a starting temperature of 1000° C. to 1250° C., preferably at 1100° C. The green body formed last can then be baked at a final temperature which determines a pore size of 0.005 μm to 5 μm, with the pore size of the filtering membrane being adjustable through targeted grain growth by means of the level of the baking temperature. With the method according to the invention, filtering membrane with a defined pore size of 0.005 μm to 5 μm and layer thicknesses of between 1 μm and 10 μm can thus be produced. During the baking of the green body, the nitride/metal particles grow epitaxially at their points of contact through phase change into oxides, proceeding from the particle surface into the interior.

The examples described in the following relate to preferred embodiments of the method according to the invention, although it should be pointed out that the teaching of the invention is limited neither to the selection of components shown nor to the process conditions shown.

### EXAMPLE 1

TiN powder is mixed in a ratio of approx. 1:50 with water which contains an organic gel-forming agent. The thus-obtained suspension is applied through dipping or spraying onto a ceramic support to deposit a green membrane. Subsequently, the green membrane is baked in an oven at a temperature of approx. 800° C. to 1250° C., with a porous TiO₂ micro- or ultrafiltration membrane with an average pore diameter of about 0.05 μm to 1.8 μm being obtained.

### EXAMPLE 2

TiM powder is mixed in a ratio of approx. 1:100 with propanol and an organic gel-forming agent. The thus-obtained suspension is applied through dipping or spraying onto a ceramic support to deposit a green membrane. Subsequently, the green membrane is baked in an oven at a temperature of 500° C. to 1000° C., particularly at a temperature of >700° C. to 1000° C., with a porous TiO₂ ultrafiltration membrane with an average pore diameter of about 0.02 μm to 0.1 μm being obtained.

In the only figure of the drawing, the dependence of the pore diameter d of a ceramic filtering membrane obtained using the method according to the invention on the temperature level of the baking process is depicted. It follows from the figure that the pore size or pore diameter can be adjusted depending on the temperature level of the baking process. As the temperature T increases, the pore diameter d increases exponentially.

Moreover, it should be noted that a method has been developed in connection with the invention that facilitates the detection of the use of the method according to the invention in the manufacture of a ceramic filter or the use of a suspension according to the invention. The detection method conveyed in connection with the invention makes it easier and quicker to check ceramic filters for whether they have been produced using the method according to the invention or whether a suspension according to the invention has been used.

In conclusion, it shall be noted that all range indications named in connection with the description of the invention may include all values within the indicated ranges, even if this has not been specifically emphasized.

1. Method for producing a reaction-bound ceramic filtering membrane, wherein a porous metallic or non-metallic support is provided with a suspension for the production of a green body, wherein the suspension is obtained from a dispersing agent and a disperse phase, wherein the disperse phase can be obtained from titanium nitride and optionally at least one other ceramic material, and whereby the green body produced in this manner is baked at a temperature of 700° C. to 1250° C., wherein the green body is baked under atmospheric pressure in oxidizing atmosphere for the formation of titanium oxide from titanium nitride.

2. Method as set forth in claim 1, wherein one nitride of the metals zirconium and/or aluminum is used as a further ceramic raw material.

3. Method as set forth in claim 1, wherein the other ceramic raw material is selected from the group of the metals, particularly titanium and/or zirconium and/or aluminum, and/or from the group of the metal oxides, particularly titanium oxide and/or zirconium oxide and/or aluminum oxide.

4. Method as set forth in claim 1, wherein the phase change is carried out at 800° C. to 1000° C.

5. Method as set forth in claim 1, wherein a ceramic raw material and/or another ceramic raw material with a particle size of between 0.005 μm to 5 μm is selected.

6. Method as set forth in claim 1, wherein the proportion of the disperse phase with respect to the mass of the dispersing agent is set at approx. 0.1 wt. % to 20 wt. %.

7. Method as set forth in claim 1, wherein water and/or at least one alcohol and/or at least one organic gel-forming agent and optionally at least one organic dispersing agent is used as a dispersing agent.

8. Method as set forth in claim 1, wherein the proportion of the organic gel-forming agent with respect to the mass of the dispersing agent is set at approx. 0.1 wt. % to 5 wt. %.

9. Method as set forth in claim 1, wherein the proportion of the dispersing agent with respect to the mass of the disperse phase is set at approx. 0.1 wt. % to 100 wt. %.

10. Method as set forth in claim 1, wherein the suspension is applied onto the support through dipping, spraying, brushing, slinging or pumping through a preferably tubular support.

11. Method as set forth in claim 1, wherein the contact time between the support and the suspension during dipping or pumping is set at between approx. 1 s to 60 s.

12. Method as set forth in claim 1, wherein the green body is dried before baking, preferably at a temperature of approx. 20° C. to 250° C. and at atmospheric pressure.

13. Method as set forth in claim 1, wherein the suspension is applied multiple times to the support, with the green body preferably being dried and/or baked after each application of the suspension.

14. Method as set forth in claim 1, wherein the baking temperature is decreased incrementally during each successive baking process in order to produce a pore structure of the filtering membrane with decreasing pore size.

15. Method as set forth in claim 1, wherein the initially formed green body is baked at a starting temperature of 1000° C. to 1250° C., preferably at 1100° C., and that the green body formed last is baked at a final temperature which determines a pore size of 0.005 μm to 5 μm.

16. Method as set forth in claim 2, wherein the other ceramic raw material is selected from the group of the metals, particularly titanium and/or zirconium and/or aluminum, and/or from the group of the metal oxides, particularly titanium oxide and/or zirconium oxide and/or aluminum oxide.
